(19) United States
(12) Patent Application Publication
(10) Pub. No.: US 2009/0019176 A1
(43) Pub. Date: Jan. 15, 2009

(54) Live Video Collection And Distribution System and Method

(76) Inventor: Jeff Debrosse, Poway, CA (US)

Correspondence Address: MINTZ, LEVIN, COHN, FERRIS, GLOVSKY AND POPEO, P.C;ATTN: PATENT INTAKE CUSTOMER NO. 64046, ONE FINANCIAL CENTER, BOSTON, MA, 02111, US

(21) Appl. No.: 12/172,947

(22) Filed: Jul. 14, 2008

Related U.S. Application Data
(60) Provisional application No. 60/959,555, filed on Jul. 13, 2007.

(51) Int. Cl. G06F 15/16

(52) U.S. Cl. 709/231

(57) ABSTRACT

A live video streaming unit and method for streaming live video through a network to a number of viewers are disclosed. The live video streaming unit is sized and adapted for being worn on a person, and is configured to capture, encode and stream audio and video in real time from any location over a wireless network to a server. The collected live video and audio streams from the live video streaming units worn by the of users is then transmitted to at least one server over the wireless network.

### CROSS REFERENCE TO RELATED APPLICATION

This application claims the benefit under 35 U.S.C. Section 119(e) of a provisional application U.S. Ser. No. 60/959,555, entitled “Live Video Collection And Distribution System And Method,” filed Jul. 13, 2007 (Attorney Docket No. 36374-501-PRO), which is incorporated by reference herein.

### BACKGROUND

This disclosure relates generally to video streaming technologies, and more particularly to a system and method for wirelessly collecting live, line-of-sight video from a scalable number of content originators, and process the video for access by users of a client computer.

The current state of the art of multimedia communications includes live streaming of video content. Technologies such as “webcams” allow a content originator to capture video content from a stationary video camera, and then transmit the video content to a server where it is accessible to any user from a client computer. More recently, some content originators carry video cameras for a more dynamic experience—i.e. to target the video camera on some external action, to more closer approximate an experience of “being there” by a user of a client computer.

sting live mobile streaming video solutions are limited because of the complexity of assembling and integrating the operation of multiple components and processes, making it beyond the reach of most consumers. Currently, when a user needs to produce live mobile streaming video the user requires: (a) a computer, (b) a wired or wireless camera that must be connected to the computer, (c) camera software and drivers, (d) a portable power source, and (e) a reliable internet connection at the location of the live event. For the majority of people that would like to stream live content over the Internet while remaining mobile, these steps are cumbersome and difficult.

At the content origination side, existing live mobile streaming video solutions are not readily wearable without significant modifications, and even with the required modifications must be adapted to a computer and a transport system (wired/wireless) that will then stream the live event over the internet. The resources required to accomplish this are not always easily assembled, especially when attempting to transmit live events from a mobile platform.

Viewing live events over the Internet is generally recognized as a source for instant emotional impact to the viewers. As the Internet continues to mature and new products and services emerge to take advantage of this globally-connected network, the most prevalent application on the Internet today is video. While some companies excel at providing on-demand viewing of stored video content, they have yet to recognize the large market to which live video can provide.

With a low-cost and easy-to-use device, users can broadcast a live event at a moment's notice—providing the viewing public with the means to see, and hear, more dynamic and spontaneous programming than has been ever available in the history of television or Internet video. However, a major bottleneck when considering providing live streaming video from a mobile platform is the available bandwidth over wireless broadband networks due to their inherent architectures.

### SUMMARY

In general, this document discusses a system and method that allows a mobile user to very quickly stream live video over the internet without external cameras, computers or associated software and drivers. The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is a functional block diagram of an integrated live streaming video unit that collects live video.

FIG. 2 illustrates an integrated live video streaming unit as an earpiece that provides first-person, line-of-sight collection of video signals.

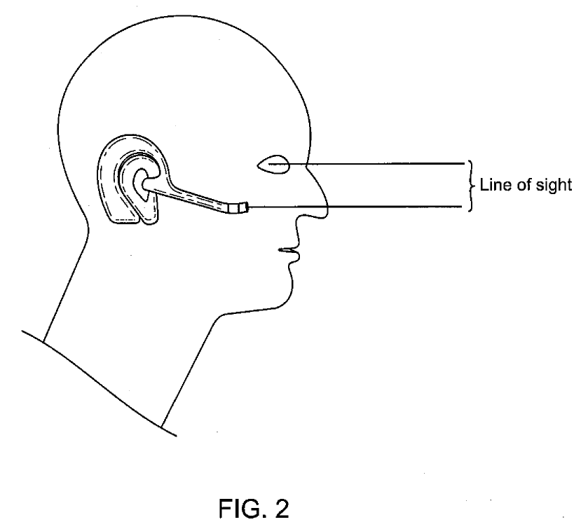

FIG. 3 illustrates a live video collection and distribution system.

Like reference symbols in the various drawings indicate like elements.

### DETAILED DESCRIPTION

The Integrated Live Streaming Video (ILSV) system is a hardware and software system including one or more wearable or portable devices to stream live video over the Internet wirelessly using a cellular telephone network. The term “live video” as used herein describes any streaming video content (including audio) that is captured by an Integrated Live Streaming Video Unit (ILSVU) and forwarded via wireless IP to a web site that will aggregate live video from numerous ILSVUs as well as other live video sources from non-mobile cameras.

Each portable device includes an ILSVU which transmits video and audio images over a wireless cellular connection and streams it to a destination on the Internet. The ILSVU is composed of a tiny video camera, microphone, necessary circuit board to route signals to the various processing elements, a microprocessor to encode and decode video and audio media signals, a wireless transmitter with antenna using a technology such as Bluetooth, GSM, or any other wireless data protocol. Streaming audio/video to the Internet is accomplished by either of two methods: (1) wireless connectivity from the ILSVU to a mobile phone—with the mobile phone providing the connectivity to the Internet, (2) directly from the ILSVU to the cellular carrier using an integrated wireless transmitter with antenna such as GSM or other wireless cellular technology. Each ILSVU has a unique identity which references an account profile that establishes rules and permissions for that stream on any affiliated network on the Internet.

The account profile is established by users who provide personal account information, and which enables users to participate in the ILSV system. The account profile provides the parameters, preferably in the form of metadata, by which live streaming video can be searched for, accessed, and/or downloaded by a user. This metadata, or other metadata generated specifically as the system receives video content, provides the “hooks” for searching and retrieving the live content video data.

The ILSV system and method provide a wearable live video streaming device, the ILSVU, that allows for continuous, hands-free operation during the transmission of the live streaming video, thereby allowing the user to provide a first-person perspective to the remote viewers. Each ILSVU includes: a color camera for video capture, a microphone (such as a directional microphone) for sound capture, a small speaker/earpiece that the user receives audible cues/notifications, buttons for controlling the recording/power (on/off) and earpiece volume (increase/decrease). The ILSVU can be integrated into a unitary earpiece housing that is light, comfortable and nonobtrusive.

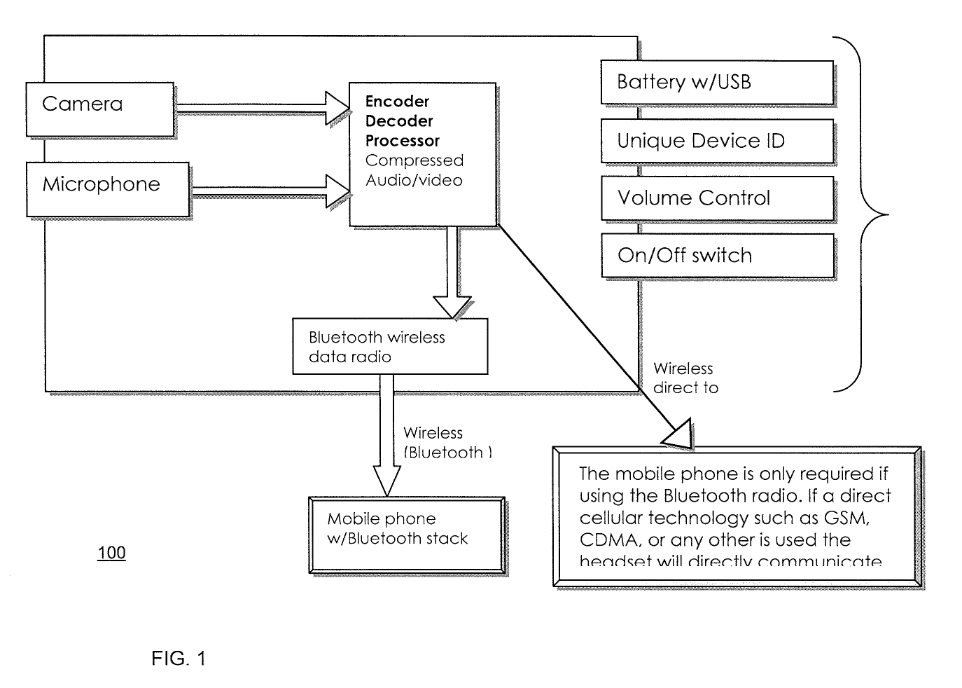

The video camera preferably uses a compression method for optimizing the size of the transmitted stream (FIG. 1). This provides more efficient utilization of precious wireless bandwidth. Although audio/video broadcasts are typically perceived as requiting large amounts of bandwidth and processor power, the ILSVU uses an efficient video compression codec (such as DivX, MPEG-4/H.264, or others—which can achieve data compression ratios of 100:1) as well as an efficient audio encoding codec (such as AAC or MP3). Because the cameras will utilize efficient codecs for audio and video compression—the viewers will experience excellent quality with low latency—although latency will also be determined by the relaying partner's video broadcasting architecture and the viewer's internet connection. Although not required, the ILSVU can utilize encryption for secure transmission of content.

In some preferred exemplary implementations, the camera provides streaming video at data rates ranging from 56 Kbps (low-quality web casts) to 128 Kbps (good quality web video), generating up to 30 frames per second with a correspondingly appropriate video size (such as 320×240—which is also know as QVGA). Higher data rates and video sizes can be accommodated but the wireless carrier's network will have to be able to support the higher data rates to provide an acceptable level of quality from the viewers.

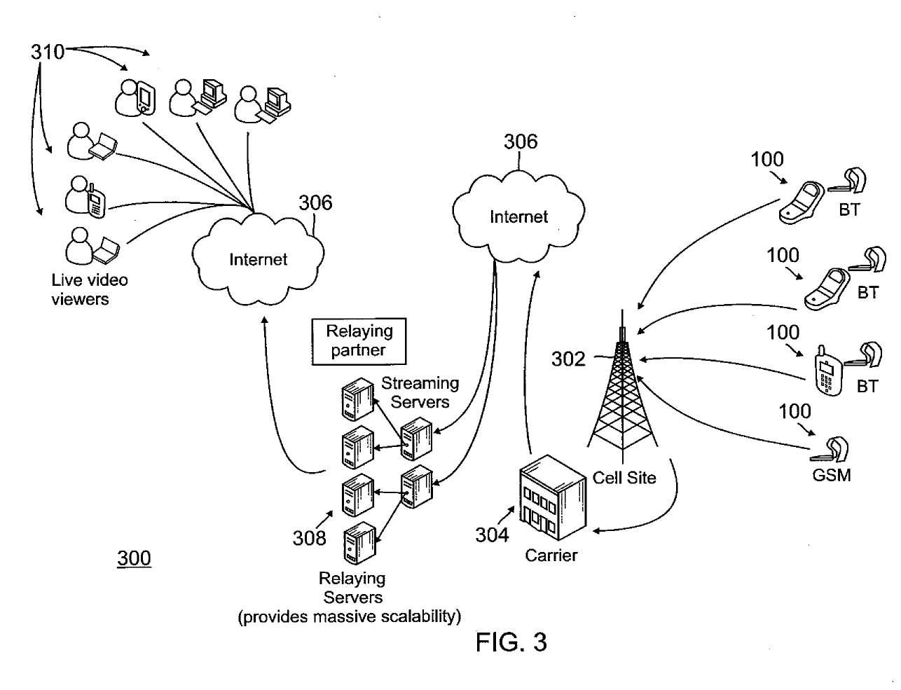

FIG. 3 illustrates a live video collection and distribution system 300, in which a number of ILSVUs 100 collect video content as described above. The ILSVUs 100 wirelessly transmit, in real-time or near real-time, first-person video content through a cell site 302 to a carrier 304. The carrier 304 sends the video content to the Internet 306, where it is forwarded to one or more servers 308. The servers 308 can include relaying servers and mirror servers for massive scalability, as well as streaming servers for distributing the video content in an organized user interface through the internet 306 to any of a number of users of client computers 310. The client computers 310 can include, without limitation, personal computers, hand-held devices such as smart cellular phones, and laptop computers.

Video streams are directed to a particular Internet destination based on a user profile that is stored in a database associated with the unique hardware identification number of the transmitting ILSVU. By directing the audio/video content streams in this way, it is not necessary to aggregate all streams into a central server—the streaming feeds go directly to their pre-programmed destination or destinations via routing through the cellular carrier network. Users may control where the stream will be routed by setting preferences in a Web-based user account associated with the ILSVU and an associated network subscription. A relatively simple interface can be used to set the desired network targets for the streaming media.

Some of the live streaming video applications that the system 300 can facilitate include live performances, real estate inspection, entertainment such as pay-per-view for live content, celebrity sightings, interviews, security, health and medicine, training and education, live customer service, insurance, sales, law enforcement, military, video-enhanced commerce (i.e. “v-commerce”), demonstrations and other site inspections. The live streaming video can be accessed according to any of a variety of parameters, such as timeframe, geolocation, event (such as specific event, event type, genre, etc.) or based upon parameters associated with each account profile, such as personal interests, hobbies, habits, etc.

Some or all of the functional operations described in this specification can be implemented in digital electronic circuitry, or in computer software, firmware, or hardware, including the structures disclosed in this specification and their structural equivalents, or in combinations of them. Embodiments of the invention can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments of the invention have been described. Other embodiments are within the scope of the following claims. For example, the steps recited in the claims can be performed in a different order and still achieve desirable results. In addition, embodiments of the invention are not limited to database architectures that are relational; for example, the invention can be implemented to provide indexing and archiving methods and systems for databases built on models other than the relational model, e.g., navigational databases or object oriented databases, and for databases having records with complex attribute structures, e.g., object oriented programming objects or markup language documents. The processes described may be implemented by applications specifically performing archiving and retrieval functions or embedded within other applications.

What is claimed:

1. An apparatus comprising:
a live video streaming unit that captures, encodes and streams audio and video in real time from any location over a wireless network to a server, the live video streaming unit being sized and adapted for being worn on a person.

2. An apparatus in accordance with claim 1, wherein the live video streaming unit is further sized to fit on the person's ear.

3. An apparatus in accordance with claim 1, wherein the live video streaming unit is sized and adapted to provide a video capture angle associated with a line-of-sight of the person.

4. An apparatus in accordance with claim 1, wherein the live video streaming unit includes an interface to a wireless radio device.

5. An apparatus in accordance with claim 4, wherein the interface includes Bluetooth.

6. An apparatus in accordance with claim 4, wherein the wireless radio device is a cellular telephone.

7. A method for aggregating video data, the method comprising
collecting live video and audio streams by a plurality of users wearing a live video streaming unit, the live video streaming unit having an interface to a wireless network; and
transmitting the collected live video and audio streams from the live video streaming units worn by the plurality of users to at least one server over the wireless network.

8. A method in accordance with claim 7, further comprising storing the transmitted and collected live video and audio streams based on an account profile established by each of the plurality of users.

9. A method in accordance with claim 7, wherein collecting live video and audio streams by a plurality of users wearing a live video streaming unit further includes positioning one or more of the live video streaming units to capture a video angle associated with a line-of-site of an associated user of the plurality of users.

10. A method in accordance with claim 7, wherein transmitting the collected live video and audio streams further includes encoding and compressing the live video and audio streams by one or more of the live video streaming units.
